(19) United States
(12) Patent Application Publication
(10) Pub. No.: US 2002/0145769 A1
(43) Pub. Date: Oct. 10, 2002

(54) Digital cameras

(76) Inventor: Stephen B. Pollard, Nr Dursley (GB)

Correspondence Address: HEWLETT-PACKARD COMPANY, Intellectual Property Administration, P.O. Box 272400, Fort Collins, CO, 80527-2400, US

(21) Appl. No.: 10/073,079

(22) Filed: Feb. 12, 2002

(30) Foreign Application Priority Data
Feb. 16, 2001 (GB) 0103831.4

(51) Int. Cl. H04N 1/46

(52) U.S. Cl. 358/504; 358/509

(57) ABSTRACT

An image capture apparatus is disclosed which includes a digital camera (101) having a detector (107), a light source 106 which illuminates a document (102) to be captured, a read out circuit (108) which captures an image of the document (102) from the detector (107) and a memory with accommodation calibration information. The captured image is processed together with the calibration information which is dependent upon the illumination of the light incident upon the document. The final image produced after applying the calibration information is substantially free of the effects of uneven illumination from the light source (106). A method of capturing an image from the apparatus is also disclosed. Optionally, the detector is a color detector and the calibration information is applied to the raw captured data prior to color plane reconstruction.

This invention relates to the field of digital cameras. It in particular, but not exclusively, relates to digital cameras configured to capture an electronic image of a document which is largely free from the effects of non-uniform illumination of the document.

The most widely used devices for the capture of electronic images of documents are flat-bed and sheet fed scanners. In the flat-bed scanner a document is placed on a platten. A light source and a detector are moved across the document to capture an image. In the sheet fed scanner the light source and the detector are fixed in place and the document is moved relative to the detector by a sheet feeder.

In both the flat-bed and sheet feed scanners the light source and detector are supported in close proximity to the document. This allows the amount of light incident upon the document and which is diffusely reflected to the detector to be tightly controlled. As such, high quality images can be obtained.

An alternative device which can be used to capture an electronic image of a document is the digital camera. This typically comprises a detector and a light source which are positioned at a distance above a document to be captured. To avoid specularities in the captured image it is usual to position the light source at an oblique angle to the document so that any speculary reflected light is outside of the field of view of the detector. Also, by using a bright light such as a flash and a closely bracketed exposure time the effects of ambient light can be minimised.

A problem with the use of a flash light, and in particular an obliquely arranged light, is that the intensity profile of the illumination of the final image in which the effects of non-uniformity have been substantially removed.

The invention thus provides for processing of a captured image with calibration information to remove the effects of uneven lighting from a final image.

The calibration information may comprise a plurality of individual calibration values corresponding to respective data values in the captured image.

Each calibration value may correspond to the data value produced by the respective pixel in the detector when capturing an image of a predetermined test sample. In this case, the processor may divide each data value in a captured image by the corresponding calibration value. The result of the division may subsequently be multiplied by an amount dependent upon the known colour and reflectance of the test sample.

Alternatively, the calibration values may comprise scaling values, each scaling value dependent upon the data value obtained from a pixel when capturing the test image. In this case, the processor may multiply each data value by its corresponding calibration value to produce the required value for the final image.

The captured image may comprise one data value for each detection element in the detector. The memory may then conveniently store a calibration value for each of the data values in the captured image.

Alternatively, the memory may store calibration values for a selection of the detection elements and the processing means may be configured to interpolate between two or more of the stored calibration values to determine the calibration value for an individual data value in a captured image. This is advantageous as it reduces the amount of memory required. The results are typically satisfactory for document capture as the illumination profile will typically only change gradually across the document.

For example, where the detection elements are arranged in a grid the memory may store calibration values for every alternate detection element in the grid and interpolate the values for the intermediate detection elements by averaging the stored calibration values of the adjacent elements.

The detector may comprise a mono-chromatic detector comprising a plurality of detection elements which are sensitive to the same range of light wavelengths. In this case the calibration values a will represent the sensitivity of the detection elements to that range of wavelengths.

In a refinement, the detector may comprise a colour detector comprising at least two sets of detection elements arranged in a predetermined pattern, a first set of detection elements having a first spectral sensitivity and the second set having a second, different, spectral sensitivity.

Where a colour detector is provided the read-out means may capture an image of the document which comprises two sets of data values, a first set comprising a plurality of data values obtained from the first detection elements and the second set comprising a plurality of data values obtained from the second set of detection elements.

The memory may store two subsets of calibration information, with one sub-set for each of the two parts of the captured image.

In a most convenient arrangement three sets of detection elements are provided, each having a different spectral response. The three sets may be predominantly sensitive to red, green and blue light.

The three sets of colour sensitive pixels may be arranged in an RGB Bayer pattern or any other known pattern known as a colour mosaic.

Preferably, the data values defining the first, second and third sub-images are processed with the calibration information prior to colour plane construction of the final image.

Performing the calibration on the raw colour data prior to colour plane construction is advantageous as it will require only one third of the calculations. It will also allow imbalance in illumination across the different colour pixels to be performed.

The image capture apparatus may include a low pass filter and the processor may pass the calibration information through the filter. The low pass filter may be either a frequency domain or spatial domain filter. Such a filter is advantageous in reducing noise in the final image.

The apparatus may include a test document of known colour, and in which the read-out circuit is configured to capture a test image corresponding to the test document, the processing means being configured to determined the calibration information from the test image and store the calibration information in the memory.

The test document may comprise a image having a uniform reflectivity and colour. This makes the calibration process easier. The image may be printed onto a sheet of paper or card or the like. In one arrangement the test document may comprise a blank sheet of plain (white) A4 paper.

Of course, other test documents may be used provided that the processor has a knowledge of the pattern on the test document.

The calibration profile may be determined once during use of the camera in response to a user command. This may be performed in the factory before the camera is sold.

Alternatively, the profile may be calculated many times at the demand of a camera user. This allows gradual changes in profile to be compensated.

In a further alternative, the processing means may include averaging means which monitors the average data value for a detection element in a number of captured images, and generates calibration values from the average values. This takes advantage of the assumption that the average intensity and colour of any point in a set of captured images will be the same as the average for all the remaining points over time. It also eliminates the need for a test document to be provided.

This may be combined with a set of calibration information initially obtained using a test image. The results of the averaging may be used to modify the stoud calibration information over time.

Whilst it is possible to provide an illumination means which comprises a single light source, the apparatus may optionally include a second light source. In this case, the apparatus may be adapted to capture a first image when the document is illuminated by the first light source, capture a second image when the document is illuminated by the second light source, and combine the two images to produce the final image.

Preferably, each of the two captured images may be combined with stored calibration information prior to combining the two images. This is especially advantageous as each light source will produce a different illumination profile across the document.

Where two light sources are used, two sets of calibration information may be stored in the memory. A first set of information may be used for the first image with the second set being used for the second image. Each set may comprise a number of sub-sets of information when a colour detector is provided.

The read-out circuit may be combined with the detector as part of the camera. The processing means may also form a part of the camera or may be provided remotely. It may, for example, comprise a computer connected to the camera by a suitable data link such as a cable.

A number of different types of detector are envisaged within the scope of the invention. An example of a suitable detector is the CCD array.

It will be appreciated that the document may be divided into several small pieces with each piece being captured in turn by the detector to build up a complete image of the document. This can be achieved by providing suitable optics which scan the document across the detector or providing and actuator which physically moves the detector. Such arrangements fall within the scope of the present invention. In each case, the calibration information that is applied to the data values captured by the detector will vary depending upon which portion of the document is being captured at any one time.

The or each light source of the illumination means may form a part of the camera or may be mounted remotely from the camera. For example, a stand may be provided which supports the camera and the illumination means may be supported by the stand. It may be built into the stand if required.

In accordance with a second aspect the invention provides a method of capturing an image of a document, the method comprising the steps of: providing a test document to be captured; illuminating the test document with light from an illumination means; providing a detector having a plurality of detection elements, capturing an image of the illuminated test document using the detector, the captured image comprising a plurality of data values; and processing the data values in the captured image in combination with calibration information indicative of the illumination profile of the illumination means across the document to produce a final image.

In accordance with a third aspect, the invention provides a data carrier which includes a computer program which when running on a computer connected to a camera provides apparatus according to the first aspect of the invention or operates the apparatus in accordance with the method of the second aspect of the invention.

There will now be described, by way of example only, one embodiment of the present invention with reference to the accompanying drawings of which:

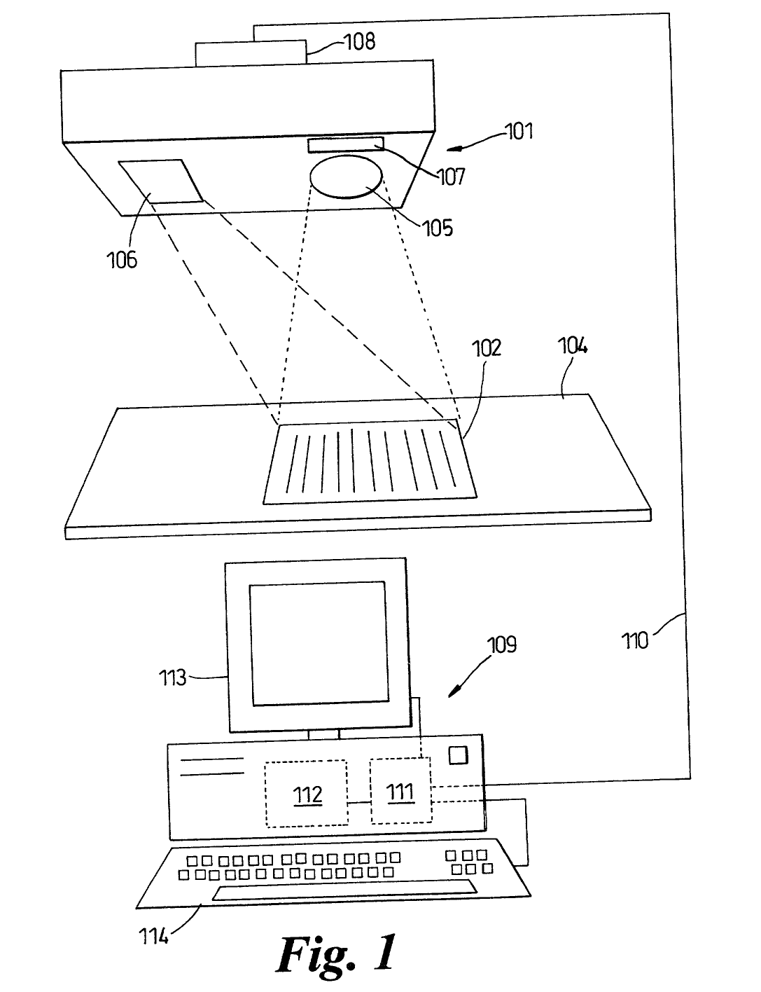

FIG. 1 is a schematic of a digital camera apparatus in accordance with a first aspect of the invention;

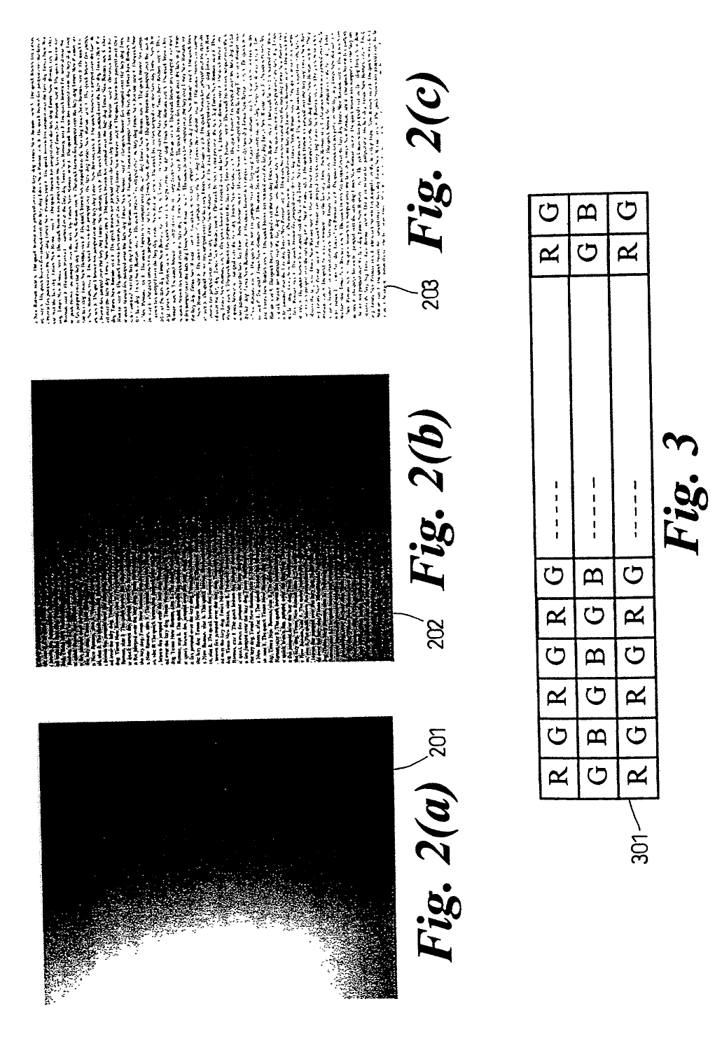

FIG. 2(a) illustrates a calibration image capture from a calibration target which is used to determine a suitable calibration profile for the apparatus of FIG. 1;

FIG. 2(b) illustrates the effects of the intensity profile on the raw captured image of a document using the apparatus of FIG. 1;

FIG. 2(c) illustrates a final image produced using the camera of FIG. 1 in which the intensity profile has been removed; and

FIG. 3 is an illustration of a typical arrangement of colour pixels in the detector array of the digital camera of FIG. 1 of the accompanying drawings.

As illustrated in FIG. 1 of the accompanying drawings, a digital image capture apparatus in accordance with the invention comprises a digital camera 101 placed directly above a document 102. The camera is maintained in fixed position by a stand (not shown) vertically above the document, which is placed on a flat surface 104 such as an area of deskspace.

The digital camera comprises a lens 105 located on a lower face of the camera 101. Also positioned on the lower face of the camera-to one side of the lens, is a light source 106. The light source emits a controlled beam of light downwards towards the document 102 which is then reflected upwards from the document. The field of view of the lens 105 and the angle at which the light is emitted ensures that any specularly reflected light from the light source 106 is not collected by the lens.

The digital camera 101 further includes a detector 107 located behind the lens 105. This comprises an array of image collecting detection elements (or nodes) which each produce an output signal when illuminated. The magnitude of the output from each element defines a data value in a captured image.

The digital camera 101 further includes a read-out circuit 108 which is adapted to produce a captured image corresponding to the output from detection elements in the detector array.

The camera read-out circuit 108 is connected to a computer 109 by an appropriate electrical cable 110. This cable 110 carries the captured image data to the remote computer 109 where it is stored in an area of memory 111. The cable 110 also carries control signals from the computer 109 to the camera. These signals turn the light source ON or OFF as required, and also control the read-out circuit to initiate the capture of an image.

The computer 109 includes a processor 112, a display 113 and an input means 114 such as a keyboard or mouse. The processor 112 is connected to the input means, the display and the memory by a communications bus (not shown) in a known manner and also to the memory 111 in which the captured image is stored.

In use of the apparatus, the document 102 is positioned below the camera 101. Operation is initiated by a user pressing a button on the keyboard or mouse 114. Upon receipt of the user input the processor 112 issues a sequence of control signals to the digital camera 101 along the cable 110 to acquire the captured image.

Because the light source is at an oblique angle to the document it does not produce an even illumination. In order to compensate for this effect the memory includes a set of calibration information which is applied to the raw data of the captured image.

The calibration data comprises an array of scaling values which are predetermined for the camera. For each element of the detector a unique value is stored in the memory. After scaling, the effects of the uneven illumination are significantly removed from the captured data.

To produce the calibration data that is stored in the memory a test image of a test document of uniform white colour is captured. If the illumination from the light source was perfect, each node of the detector would produce the same output value. However, since the intensity of the light source is uneven across the document the detection elements will produce different output values. An example of a white test document and the effect 201 of uneven illumination is provided in FIG. 2(a) of the accompanying drawings, whilst FIG. 2(b) is an example of an actual document 202 captured by the camera under the uneven illumination.

Once the test image has been obtained, the information contained therein can be used to correct the uneven illumination of the captured document. The processor stores from the test image the measured data value for each detection element of the detector. These values define calibration information which can be applied to the data values generated by the detection elements in any captured image.

Assuming that each of the stored data values from the test image are denoted Wᵢⱼ (where I and j are the horizontal and vertical positions of the data value in the captured image, and that the data values in an actual captured image are denoted Dᵢⱼ, the values Cᵢⱼ to be allocated to the final image is determined by:

Cᵢⱼ=WHITE×Dᵢⱼ/Wᵢⱼ

Where the value WHITE is the light level (intensity) required appropriate for the number of bits used to represent each intensity value (i.e. 255 for 8 bits).

To reduce the amount of noise introduced as a result of this processing the test image data values may be passed through a low pass filter.

An alternative, more efficient computation can be achieved by replacing the division operation by the stored data value Wᵢⱼ with a division by a power of 2 (which can be achieved by a shift right of N bits). In order to do this the processor may perform the following modified calculation:

Cᵢⱼ=(Dᵢⱼ×Gᵢⱼ+(1<<N−1))>>N

and

$${G}_{ij} = \frac{WHITE \times ( 1 << N )}{{W}_{ij}}$$

where Gᵢⱼ are computed gain values determined from the test image data.

These gain values are stored in array in the memory and provide all the necessary calibration information. The raw test image data values then no longer need to be stored. Of course, the raw test data values are required to determine the gain values and so may need to be stored in temporary memory after capture.

The more bits of precision given to the gain values the more accurate the division. Generally, gain values of 16 bit length are sufficient for 8 bit data values. The addition of the extra (1<<(N−1)) has the effect of rounding rather than truncating the final value.

To reduce the memory burden, the apparatus may only store gain values at a lower resolution than the resolution of the detector itself. For example, a gain value may be stored only for every second or third or fourth pixel in the array. To determine the appropriate gain value for a pixel the processing means interpolates between the stored values nearest to that pixel. This is sufficiently accurate for most applications in which the intensity profile varies only slowly across the document.

In each case, a final image is produced which is substantially free of the effects of uneven illumination. An example 203 of a final image produced for the captured document of FIG. 2(b) is given in FIG. 2(c) of the accompanying drawings.

Whilst the calibration information described hereinbefore is suitable for use with a monochromatic detector the apparatus may be provided with a colour detector. FIG. 3 of the accompanying drawings is an example of the arrangement 301 of detection elements in an appropriate colour detector. The detector differs from a monochrome device in that three different colour filters (in this example red, green and blue filters) are laid down over the detection elements in a Bayer type pattern. Of course, other patterns are suitable, and other filters may be used.

The filters divide the detection elements into three groups sensitive to the red, green and blue regions of the spectrum. Each group of elements produces a respective sub-image. These sub-images may be combined in any one of a number of known ways to produce a final coloured image.

In a similar way to the processing applied to the monochrome elements, each of the data values forming a sub-image is processed with a corresponding set of calibration information prior to production of the final coloured image. This approach is preferred as it requires only one third of the processing that would be needed after the construction of the final coloured image.

It will be appreciated that the calibration information need only be determined once for a given apparatus. Indeed, in most cases it is envisaged that a test image will be captured and the gain values determined during manufacture or upon first using the device.

As it is expected that the required calibration information stored in an individual apparatus will be predominantly determined by the type of light source used and the geometry of the camera, this data may even be produced in a lab using a test apparatus and the information simply written into memory in the camera before use.

However, it may be advantageous to perform the determination of the calibration information at various times during the life of the camera. This allows for changes in camera performance over time to be taken into account.

To allow the user to calibrate the apparatus a test image may be provided with the camera. This may simply comprise a sheet of white card of uniform colour and reflectance.

An alternative approach for producing the calibration information may also be provided which does not require a test image. In this arrangement, the average data value produced by each pixel over time may be stored in the memory. It is reasonable to expect that over an extended period the average value output from each pixel will be the same. Thus, keeping a record of the average value for each pixel provides sufficient calibration information to permit correction of uneven illumination to be achieved.

1. An image capture apparatus comprising:
a digital camera 101 comprising a detector 107 having a plurality of detection elements;
an illumination source 106 configured to emit light which illuminates a document 102 to be captured;
a read-out circuit 108 configured to capture a captured image of said document from said detector 107, said captured image comprising a plurality of data values;
a memory 111 which accommodates calibration information dependent upon an illumination profile of said light incident upon said document from said illumination source 106; and
a processor 112 configured to process each of said plurality of data values in said captured image according to said calibration information to produce a final image in which effects of non-uniformity of illumination of said document have been substantially removed.

2. Apparatus according to claim 1 wherein said calibration information comprises a plurality of calibration values corresponding to respective data values in said captured image.

3. Apparatus according to claim 2 wherein each calibration value corresponds to a data value produced by a respective detection element in said detector 107 when capturing an image of a predetermined test sample.

4. Apparatus according to claim 2 wherein said calibration values comprise scaling values, each scaling value dependent upon a data value obtained from a detection element when capturing an image of a predetermined test sample.

5. Apparatus according to claim 2 wherein said captured image comprises one data value for each detection element in said detector and in which said memory stores a calibration value for each of said data values in said captured image.

6. Apparatus according to claim 2 wherein said memory 111 stores calibration values for a selection of said detection elements and said processor means is configured to interpolate between two or more of said stored calibration values to determine a calibration value for an individual data value in said captured image.

7. Apparatus according to claim 1 wherein said detector 107 comprises a colour detector comprising at least two sets of detection elements arranged in a predetermined pattern, a first one of said sets of detection elements having a first spectral sensitivity and a second one of said sets having a second, different, spectral sensitivity, said read-out circuit being configured to capture an image of said document which comprises two sets of data values, a first set comprising a plurality of data values obtained from said first detection elements and said second set comprising a plurality of data values obtained from said second set of detection elements, and wherein said memory stores at least two subsets of calibration information, with one sub-set for each of the two parts of the captured image.

8. Apparatus according to claim 7 wherein which three sets of detection elements are provided, each having a different spectral response and said read-out circuit is configured to capture a third set of data values in addition to said first set of data values and said second set of data values.

9. Apparatus according to claim 8 wherein said data values defining said first, second and third sets of data values are processed with said calibration information prior to colour plane construction of said final image.

10. Apparatus according to claim 1 which further includes a low pass filter and wherein said processor passes said calibration information through said low pass filter.

11. Apparatus according to claim 10 wherein said low pass filter is a spatial domain filter.

12. Apparatus according to claim 1 which includes a test document of known colour, and wherein said read-out circuit 108 is configured to capture a test image corresponding to said test document, said processor being configured to determine said calibration information from said test image and store said calibration information in said memory 111.

13. Apparatus according to claim 12 wherein said test document comprises an image having a uniform reflectivity and colour.

14. Apparatus according to claim 1 wherein said processor 112 is arranged to determine an average data value for a detection element in a number of captured images, and to generate calibration values from said average data value.

15. Apparatus according to preceding claim 1 wherein an additional illumination source 106a,106b is provided which illuminates said document 102, said apparatus capturing a first image when said document is illuminated by said first illumination source 106a, capturing a second image when said document is illuminated by said second illumination source 106b, and combining said first image and said second image to produce said final image.

16. Apparatus according to claim 15 wherein said data values of each of said first image and said second image are processed with said calibration information prior to combining said two images.

17. A method of capturing an image of a document, said method comprising the steps of:
providing a test document to be captured;
illuminating said test document with light from a light source;
providing a detector having a plurality of detection elements,
capturing an image of said illuminated test document from said detector,
said captured image comprising a plurality of data values;
and processing said data values in said captured image in combination with a calibration information indicative of an illumination profile of said light source across said document to produce a final image.

18. A data carrier which includes a computer program which when running on a computer connected to a camera provides apparatus according to claim 1.

19. An image capture apparatus for capturing an image of a document comprising:
a digital camera 101 comprising a colour detector 107 having at least two sets of detection elements arranged in a predetermined pattern, a first set of said two sets of detection elements having a first spectral sensitivity and a second set of said two sets of detection elements having a second, different non uniform special sensitivity,
an illumination source 106 configured to emit light which illuminates said document to be captured with light having an illumination profile; a read-out circuit 108 configured to capture on image of said document from said detector 107, said captured image comprising at least two sets of data values, a first set of said data values comprising a plurality of data values obtained from said detection elements of said first set of detector elements and a second set of said data values comprising a plurality of data values obtained from said second set of detection elements a memory 111 which accommodates at least four sub sets of calibration information dependent said illumination profile of said light incident upon said document from said illumination source 106, with one of said sub-sets for each of said two sets of data values; and
a processor 112 configured to process each of said plurality of data-values in said captured image with said calibration information to produce an image of said documents in which the effects of non-uniformity of said illumination profile have been substantially removed.

20. Apparatus according to claim 19 wherein said calibration information comprises a plurality of calibration values corresponding to respective data values in said captured image.

21. Apparatus according to claim 20 wherein each calibration value corresponds to a data value produced by a respective detection element of said detector 107 when capturing an image of a predetermined test sample.

22. Apparatus according to claim 20 wherein said calibration values comprise scaling values with each of said scaling values dependent upon a respective data value obtained from a detection element of said camera when capturing an image of a predetermined test sample.

23. Apparatus according to claim 19 wherein said captured image comprises one data value for each detection element in said detector and in which said memory stores a calibration value for each of said data values in said captured image.

24. Apparatus according to claim 20 wherein said memory 111 stores calibration values for a fewer than the total number of said detection elements and said processor is configured to interpolate between two or more of said stored calibration values to determine said calibration value for an individual data value in said captured image.

25. Apparatus according to claim 19, wherein three sets of detection elements are provided, each having a different spectral response and said read-out circuit is configured to capture a third set of data values in addition to said first set of data values and said second set of data values.

26. Apparatus according to claim 25 wherein said data values defining said first, second and third set of data values are processed with said calibration information prior to colour plane construction of said final image.

27. Apparatus according to claim 19 which further includes a low pass filter and wherein said processor passes said calibration information through said low-pass filter.

28. Apparatus according to claim 19 wherein said low pass filter is either a frequency domain or spatial domain filter.

29. Apparatus according to claim 19 which includes a test document of known colour, and in which said read-out circuit 108 is configured to capture a test image corresponding to said test document, said processor being configured to determine said calibration information from said test image and store said calibration information in said memory 11.

30. Apparatus according to claim 29 wherein said test document comprises an image having a uniform reflectivity and colour.

31. Apparatus according to claim 19 wherein said processing means 112 is arranged to determine an average data value for a detection element across a number of captured images, and to generate calibration values from said average value.

32. Apparatus according to claim 19 wherein an additional illumination source 106a, 106b, is provided which illuminates said document 102, said apparatus capturing a first image when said document is illuminated by said first illumination means 106a, capturing a second image when said document is illuminated by said second illumination means 106b, and combining said two images to produce said final image.

33. Apparatus according to claim 32 wherein said data values of each of said two captured images are processed with said calibration information prior to combining said two images.

34. An image capture apparatus for capturing an image of a document comprising:
a digital camera 101 comprising a detector 107 having a plurality of detection elements;
a first illumination source 106a configured to emit light which illuminates said document 102 to be captured;
a second illumination source 106b configured to emit light which illuminates said document 102 to be captured
a read-out circuit 108 configured to capture a first image of said document from said detector 107, when illuminated by said first illumination source and a second image when said document is illuminated by said second illumination source the captured image comprising a plurality of data values;
a memory 111 which accommodates a first set of calibration information dependent upon the illumination profile of said light incident upon said document from said first illumination source means 106a and a second set of calibration information dependent upon the illumination profile of said light upon said document from said second illumination source; and
a processor 112 configured to process each of the plurality of data values in said first and second captured images according to said calibration information to produce two images in which the effects of non-uniformity of said illumination profiles have been substantially removed, and further to combine said processed images to produce a final image of said document.

35. Apparatus according to claim 34 wherein said calibration information comprises a plurality of calibration values corresponding to respective data values in said captured images.

36. Apparatus according to claim 35 wherein each calibration value corresponds to a data value produced by a respective detection element in said detector 107 when capturing an image of a predetermined test sample.

37. Apparatus according to claim 35 wherein said calibration values comprise scaling values, each scaling value dependent upon a respective obtained from a detection element when capturing an image of a predetermined test sample.

38. Apparatus according to claim 35 wherein each of said captured images comprise one data value for each detection element in said detector and in which said memory stores a calibration value for each of said data values in said captured image.

39. Apparatus according to claim 35 wherein said memory 111 stores calibration values for a selection of said detection elements and said processor is configured to interpolate between two or more of said stored calibration values to determine a calibration value for an individual data value in said captured images.

40. Apparatus according to claim 34 wherein said detector 107 comprises a colour detector comprising at least two sets of detection elements arranged in a predetermined pattern, a first set of detection elements having a first spectral sensitivity and the second set having a second, different, spectral sensitivity, said read-out circuit being configured to capture a first image of the document which comprises two sets of data values, a first detection elements and the second set comprising a plurality of data values obtained from the second set of detection elements, and in which the memory stores at least two subsets of calibration information, with one sub-set for each of the two subsets of calibration information, with one sub-set for each of the two parts of the captured image.

41. Apparatus according to claim 40 wherein three sets of detection elements are provided, each having a different spectral response and wherein said read-out circuit is configured to capture a third set of data values in addition to said first set of data values and said second set of data values.

42. Apparatus according to claim 8 wherein said data values defining said first, second and third sets of data values are processed with the calibration information prior to colour plane construction of the final image.

43. Apparatus according to claim 34 which further includes a low pass filter and in which said processor passes said calibration information through said filter.

44. Apparatus according to claim 43 wherein said low pass filter is either a frequency domain filter.

45. Apparatus according to claim 34 which further includes a test document of known colour, and in which said read-out circuit 108 is configured to capture a test image corresponding to said test document, said the processor being configured to determine said calibration information from said test image and store said calibration information in said memory 111.

46. Apparatus according to claim 45 wherein said test document comprises an image having a uniform reflectivity and colour.

47. Apparatus according to claim 34 wherein said processor 112 determines an average data value for a detection element in a number of captured images, and generates calibration values from said average values.
